(19) United States
(12) Patent Application Publication
(10) Pub. No.: US 2015/0200896 A1
(43) Pub. Date: Jul. 16, 2015

(54) DISPLAYING INBOX ENTITIES AS A GRID OF FACETED TILES

(71) Applicant: Hewlett Packard Development Company, L.P., Houston, TX (US)

(72) Inventors: Oded Klimer, Yehud (IL); Eitan Katz, Yehud (IL); Kobi Eisenberg, Yehud (IL); Oren Shalev, Yehud (IL); Asaf Yishai, Yehud (IL)

(73) Assignee: Hewlett Packard Development Company, L.P., Houston, TX (US)

(21) Appl. No.: 14/421,115

(22) PCT Filed: Sep. 25, 2012
(86) PCT No.: PCT/US2012/057133

§ 371 Date: Feb. 11, 2015

(51) Int. Cl. H04L 12/58; G06F 3/0484

(52) U.S. Cl. CPC H04L 51/22; G06F 3/04842

(57) ABSTRACT

Displaying inbox entities are displayed as a grid of faceted tiles includes causing a display of a tile grid that includes a faceted tile for each of a plurality of inbox entities. A first facet of each tile includes data corresponding to the inbox entity the faceted tile represents. Upon detecting a first user interaction with the first facet of a first displayed tile, a second facet is caused to replace the first facet of the first displayed without substantially affecting any other displayed tile. The second facet includes a first control for interacting with the inbox entity represented by the first displayed tile.

### CROSS-REFERENCE TO RELATED APPLICATION

The present application is the U.S. National Stage under 35 U.S.C. §371 of International Patent Application No. PCT/US2012/057133, filed 25 Sep. 2012 the disclosure of which is hereby incorporated by reference.

### BACKGROUND

Certain applications present data items to a user in what is commonly referred to as an inbox. Such data items can be referred to as inbox entities and can represent items such as email messages, tasks, calendar items, and the like. In an IT environment, inbox entities can include network incidents or application defects to be addressed. Many other examples exist. Typically, the inbox entities are presented in a vertical list. A user selects a given inbox entity which cases the display of a new window through which the user can manipulate that entity.

### DRAWINGS

FIG. 1 is a screen view depicting inbox entities displayed as a grid of faceted tiles according to an example.

FIG. 2 is a screen view depicting an example of a faceted tile with a particular layout.

FIGS. 3A-3C are example block diagrams depicting other example layouts for a faceted tile.

FIGS. 4 and 5 are example screen views depicting a user interacting with a facet of a displayed tile in differing manners.

FIG. 6 is a screen view depicting an example of a selected tile in which a second facet has replaced a first facet.

FIG. 7 is a block diagram depicting a system according to an example.

FIG. 8 is a block diagram depicting a memory resource and a processing resource according to an example.

FIGS. 9 and 10 are flow diagrams depicting steps taken to implement examples.

### DETAILED DESCRIPTION

### Introduction

Various embodiments described below were developed to present an inbox as a grid of faceted tiles such that a user can interact with a displayed tile to take action with respect to an inbox entity without disturbing the display of other tiles. A user can interact with a selected tile causing the display to change from one facet to another independent of the other displayed tiles. In other words, while interacting with a given tile to manipulate a corresponding inbox entity, the other tiles remain visible to the user. The differing facets allow for differing user interactions. One facet may simply display information describing the inbox entity. Another facet of the same tile may include a control through which the use can manipulate the corresponding entity.

In view of ever increasing screen sizes, such can prove beneficial over the traditional approach where inbox entities are displayed as a vertical list of items, and the selection of a given item opens a window that often covers the list preventing the user from viewing the other inbox entities. Moreover, the vertical list of a traditional inbox displays an inventory of homogenous entity types such as emails. A grid of tiles allows a common inbox to contain (and the user to manipulate) entities of varying types.

The following description is broken into sections. The first, labeled “Illustrative Examples,” presents examples of faceted tiles and in inbox displaying a grid of faceted tiles. The second section, labeled “Components,” describes examples of various physical and logical components for implementing various embodiments. The third section, labeled as “Operation,” describes steps taken to implement various embodiments.

### ILLUSTRATIVE EXAMPLES

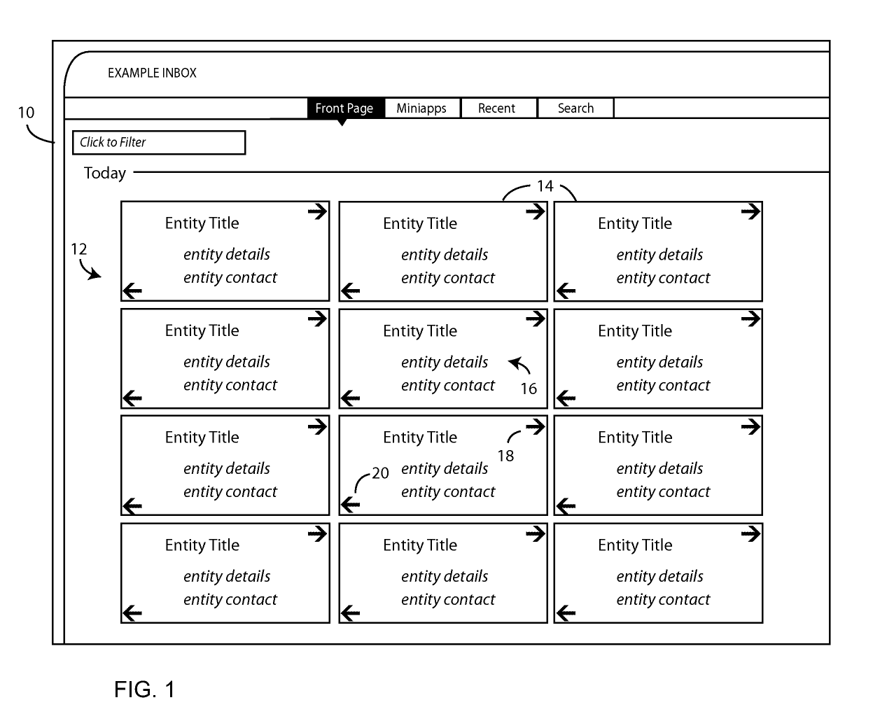

FIGS. 1-6 depict various examples of faceted tiles. Faceted tiles are data objects designed to be displayed in a grid where at least some of the tiles in the grid have two or more facets. Each facet, when displayed, is a two dimensional space in which information such as text, icons, controls and any other information can be presented to a user. A tile is multifaceted if when displayed it can be interacted with to reveal different facets. For example, upon initial display a first facet may be visible. Following a user interaction with that first facet the display is updated replacing the first facet with a second facet. In other words, based on user manipulation the display of a tile switches from one facet to another.

FIG. 1 is a screen view of an inbox 10 displaying a grid 12 of faceted tiles 14. Each tile represents an inbox entity. An inbox entity is an information item managed by an application. Examples of inbox items for a messaging and calendar application include email messages and other communications, tasks, calendar items, appointment, meeting requests and the like. In an enterprise managing an IT environment, an inbox entity may be an incident record related to a problem on a network or with an application. Another inbox entity may represent a defect record related to a defect in an application being developed by the enterprise. Of course, other possibilities may exist. Further, grid 12 can include tiles 14 representing a homogeneous or a heterogeneous group of inbox entity types.

Each tile 14 in FIG. 1 is displayed showing a first facet that includes data 16 corresponding to the inbox entity the faceted tile represents. In this example, each tile is also shown to include controls 18 and 20 with which a user can interact to cause the display of a tile to switch to another facet. Here controls 18 and 20 may be interacted with via a mouse or other pointing device or, if displayed via touch screen, tapped. In another example, interaction may be a gesture such as a swipe across the displayed facet of a tile. The direction of the swipe may determine which facet of the tile is to be displayed.

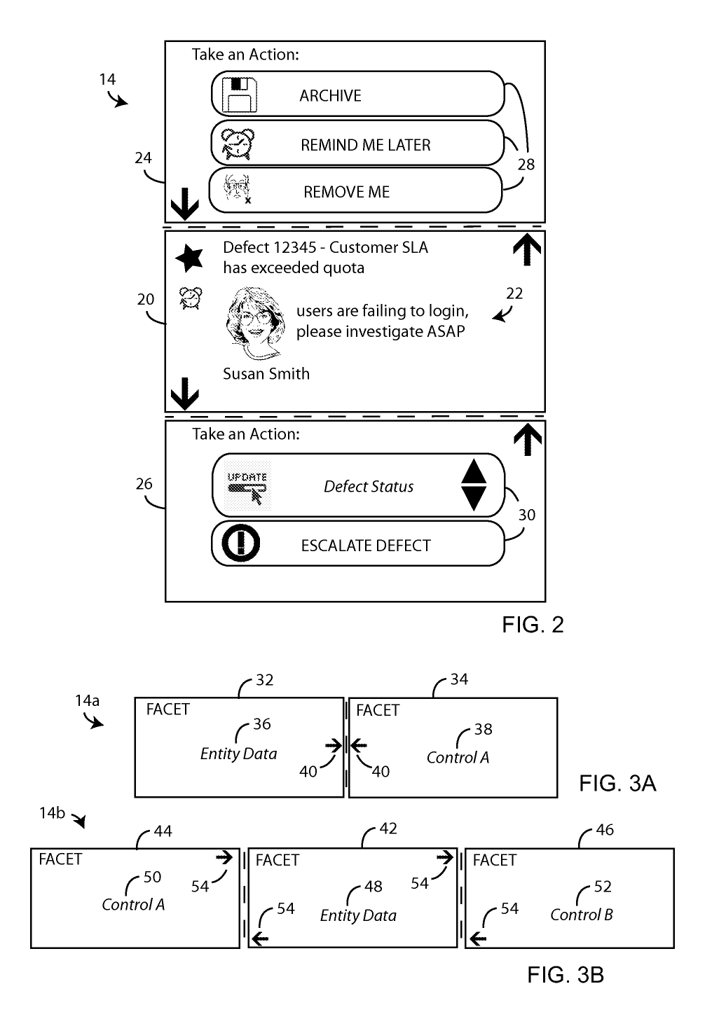

To aid in description, FIG. 2 depicts an example tile 14 and its facets independently of a grid. Here, tile 14 includes a first facet 20 containing data 22 corresponding to the inbox entity the tile 14 represents, in this case, a defect record. Tile 14 includes facets 24 and 26. Facet 24 is shown to include controls 28 (collectively referred to as a control) for manipulating the inbox entity represented by tile 14. Such manipulations can include removing the tile from an inbox, setting a reminder, or archiving the inbox entity. Facet 26 includes controls 30 (collectively referred to as a control) also for manipulating the represented inbox entity. Here, however, control 30 is unique to the type of inbox entity represented by the tile. As noted, tile 14 here represents a defect record. Control 30 here allows a user to set a status and escalate. Thus, control 30 allows a user to manipulate that defect record but would be inapplicable to an inbox entity such as an email message or an incident record.

FIG. 2 depicts an example in which the facets 20, 24, 26 of tile 14 are vertically organized. Interaction with a facet 20 can cause the display to switch to a facet 24 or 26 either above or below. It is also noted, that generally one facet 20, 24, 26 of tile 14 is displayed at a time. However, portions of two facets may be temporarily visible as the display of tile 14 is transitioned from one facet to the other of tile. Such a transition may be animated and in the example of FIG. 2, such an animation may depict tile 14 rotating or pivoting up or down relative to the display.

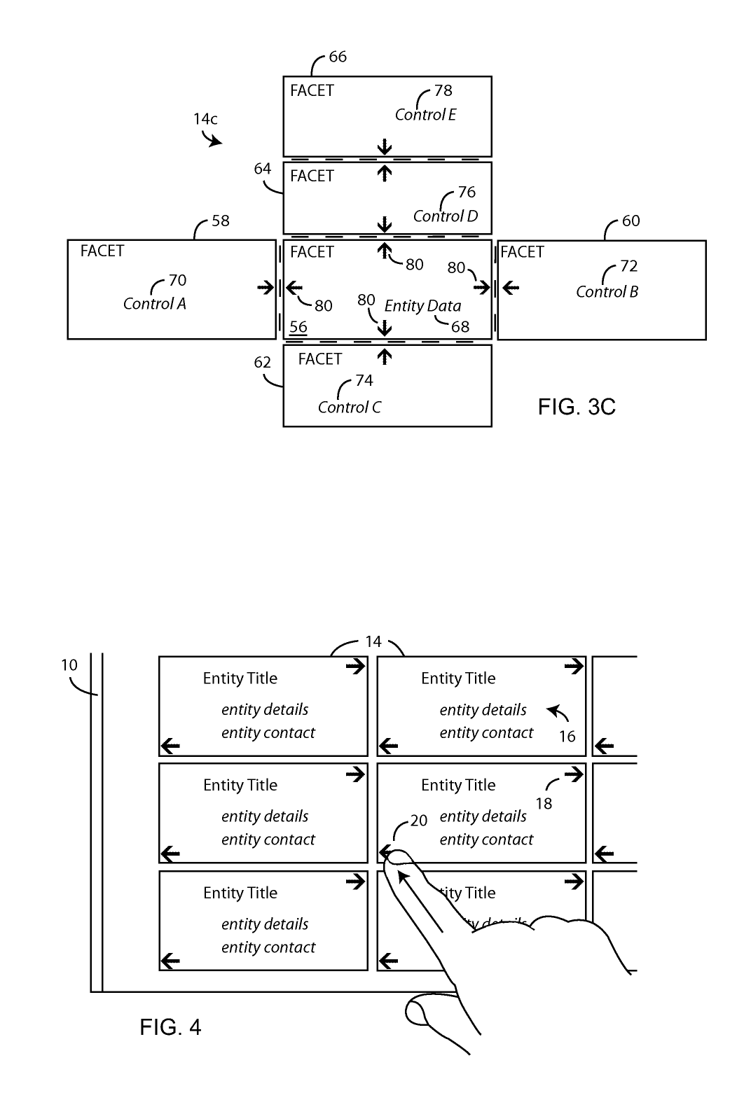

FIGS. 3A-3C depict other example layouts for tile 14. In FIG. 3A, tile 14a includes two facets 32 and 34 in a side by side orientation. Facet 32 includes data 36 corresponding to the represented inbox entity. Facet 34 contains control 38 for manipulating that represented entity. Facets 32 and 34 include controls 40 for transitioning the display of tile 14a between facets 32 and 34.

In FIG. 3B, tile 14b includes three facets 42, 44, and 46 in a side by side orientation. Facet 42 includes data 48 corresponding to the represented inbox entity. Facets 44 contains control 50, and facet 46 contains control 52. Controls 50 and 52 are for manipulating the represented entity. Facets 42-46 include controls 54 for transitioning the display of tile 14b between facets 42-46.

In FIG. 3C, tile 14c includes facets 56-66 are a multidimensional orientation. Facet 56 includes data 68 corresponding to the represented inbox entity. Facets 58-66 contains controls 70-78 for manipulating the represented entity. Facets 56-66 include controls 80 for transitioning the display of tile 14c between facets 56-66. In this example, when displayed, the facets 56-66 of tile 14c can be transitioned through as if they were facets of a cube.

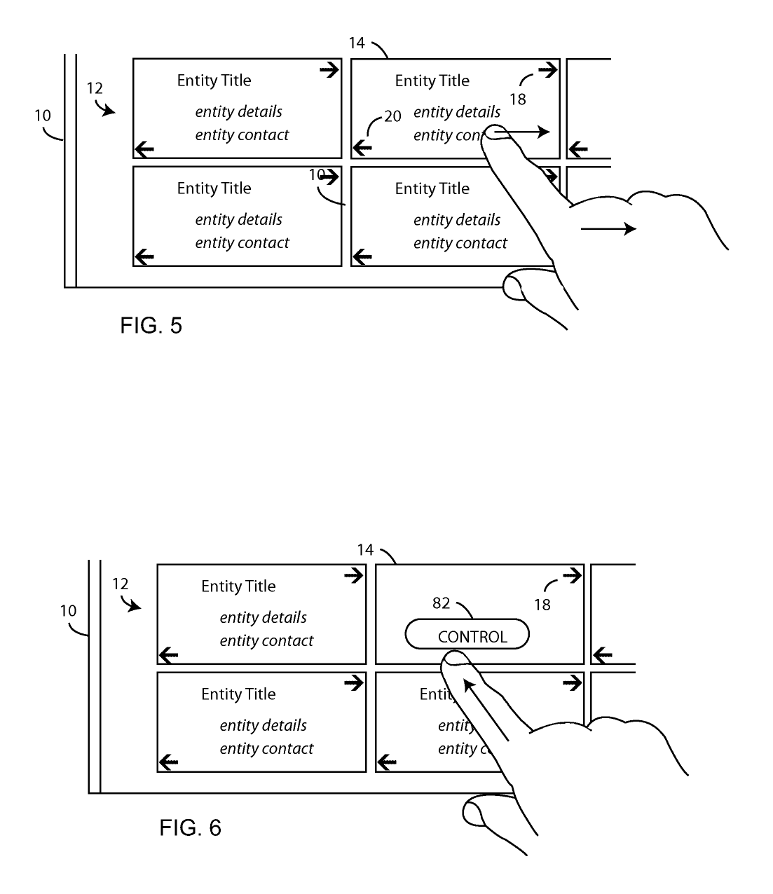

Moving on to FIG. 4, a user is depicted interacting with a facet of tile 14. Here, it is presumed inbox 10 is being displayed on a touch screen, and the user is tapping control 20. In another example, the user may be manipulating a pointing device to select control 20. In FIG. 5, user interaction with the facet of tile 14 is a gesture or swipe. The examples of FIGS. 4 and 5 are shown to illustrate different modes of user interaction with a facet of a tile that can cause the display to transition from one facet to another. Other types of interactions, are of course, possible.

Looking at FIG. 6, the user has interacted with the facet of tile 14 causing the display to transition to a new facet containing control 82 for manipulating the represented inbox entity. The transition caused one facet to replace another without affecting the display of any other tile of grid 12. Where the transition from one facet to another is animated, displayed portions of adjacent tiles may be temporarily affected or the newly displayed facet may partially overlay adjacent tiles. However, the newly transitioned facet is displayed without substantially affecting any other displayed tile. In other words, the user is able to interact with the adjacent tiles and view their contents.

### Components

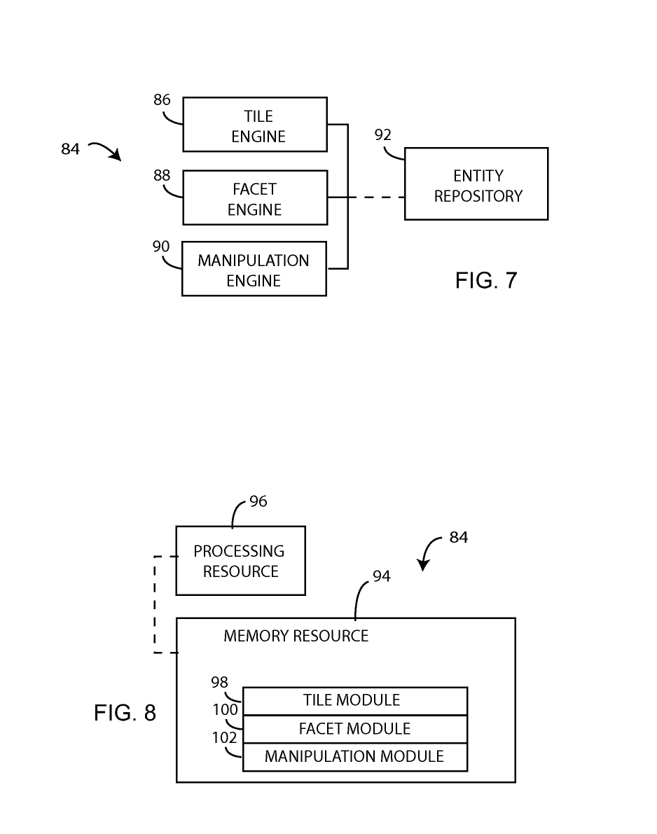

FIGS. 7-8 depict examples of physical and logical components for implementing various embodiments. In FIG. 7 various components are identified as engines 84-88. In describing engines 84-88, focus will be on each engine's designated function. However, the term engine, as used herein, refers to a combination of hardware and programming configured to perform a designated function. As is illustrated later with respect to FIG. 8, the hardware of each engine, for example, may include a processor and a memory, while the programing is code stored on that memory and executable by the processor to perform the designated function.

FIG. 7 depicts system 84 for displaying inbox entities as a grid of faceted tiles. System 84 is shown to include tile engine 86, facet engine 88, and maintenance engine 90. Also shown is entity repository 90 which represents a storage location or locations for inbox entities and related date. Tile engine 86 is configured to cause a display of a grid that includes a faceted tile for each of a plurality of inbox entities wherein a first facet of each tile includes data corresponding a particular one of the inbox entities. Tile engine 86 can cause a display in a number of fashions. For example, causing a display can include communicating instructions to be directly acted on by an operating system or driver responsible for controlling a local monitor. In another example, causing a display can include communicating data across a network to be processed by another device to display the grid. Such data for example may be content returned in response to a request from a client device.

In performing its function tile engine 86 may access entity repository 92 to identify the corresponding inbox entities. Tile engine 86 may determine or otherwise select the dimensions of the grid based upon a size of the display being used to present the gird to a user. For example, a tablet display may have a grid of tiles with a certain number of columns and rows. A larger monitor may have more columns and rows. Alternatively, the tiles displayed on the larger monitor may be larger than those displayed on the tablet. Repository 90 may include data for use by tile engine 86 to determine a desired layout of the grid. Such may be a default layout or a user defined layout.

Facet engine 88 is configured to cause, with respect to a tile selected from among the displayed tile grid, the first facet of the tile to be replaced with a second facet or a third facet chosen according to a type of user interaction with that first facet. Again, causing can be accomplished in a number of fashions such as directly interacting with the software responsible for driving the display or by returning content in response to a client request. The first facet is replaced with the second without substantially affecting the display of any other tiles. Where, for example, the tile includes three or more facets, the type of user interaction may determine which facet is the second facet selected to replace the first. A swipe in one direction may result in one facet being selected while a swipe in another direction may result in another facet being selected. Regardless, the second facet selected to replace the first includes a control for manipulating the inbox entity represented by the given tile.

Manipulation engine 90 is configured to manipulate a given inbox entity according to the user's interaction with a control included in the second facet. The nature of the manipulation depends on the particular control included in the facet selected to replace the first facet. Looking back to FIG. 2, as an example, facet 24 includes a generic control for archiving, reminding, and removing that could apply to most any inbox entity type. Facet 26 on the other hand includes a control that is unique to the type of inbox entity represented by the tile. Data repository 90 may include data for use by facet engine to determine the particular the number of facets for a given tile and the particular control, if any, included in each facet. Such data may, for example, map an inbox entity type to a particular style defining the facets and the controls for the tile. Facet engine 88 can then use that style to accomplish its function.

Thus at any given time, a user may interact with different tiles within the grid causing facet engine 88 to transition the display of those tiles from one facet to another. Where the grid caused to be displayed by tile engine 86 includes tiles representing differing types of inbox entities, the particular controls displayed in a facet can vary from tile to tile. Thus, manipulation engine 90 may manipulate a tile for an inbox entity in a manner that would not be compatible for an inbox entity of another type. As an example, an inbox entity for a calendar item might be manipulated in a manner not compatible for an inbox entity for a task item. Manipulating the calendar item may include changing a meeting location which has no context with respect to the task item. Manipulation may be direct or indirect. Direct manipulation involves affecting the data representing the inbox entity. Indirect manipulation involves communicating an instruction that when acted upon manipulates the inbox entity.

In foregoing discussion, various components were described as combinations of hardware and programming. Such components may be implemented in a number of fashions. Looking at FIG. 8, the programming may be processor executable instructions stored on tangible memory resource 94 and the hardware may include processing resource 96 for executing those instructions. Thus memory resource 94 can be said to store program instructions that when executed by processing resource 96 implement system 84 of FIG. 7.

Memory resource 94 represents generally any number of memory components capable of storing instructions that can be executed by processing resource. Such memory components being non-transitory computer readable media. Memory resource 94 may be integrated in a single device or distributed across devices. Likewise processing resource 96 represents any number of processors capable of executing instructions stored by memory resource. Processing resource 96 may be integrated in a single device or distributed across devices. Further, memory resource 94 may be fully or partially integrated in the same device as processing resource 96 or it may be separate but accessible to that device and processing resource 96. Thus, it is noted that system 84 may be implemented on a user device, on a server device or collection of servicer devices, or on a combination of the user device and the server device or devices.

In one example, the program instructions can be part of an installation package that when installed can be executed by processing resource 96 to implement system 84. In this case, memory resource 94 may be a portable medium such as a CD, DVD, or flash drive or a memory maintained by a server from which the installation package can be downloaded and installed. In another example, the program instructions may be part of an application or applications already installed. Here, memory resource 94 can include integrated memory such as a hard drive, solid state drive, or the like.

In FIG. 8, the executable program instructions stored in memory resource 94 are depicted as tile module 98, facet module 100, and manipulation module 102. Tile module 98 represents program instructions that, when executed, cause processing resource 96 to implement tile engine 86 of FIG. 7. Facet module 100 represents program instructions that when executed cause the implementation of facet engine 88. Likewise, manipulation module 102 represents program instructions that when executed cause the implementation of manipulation engine 90.

### Operation

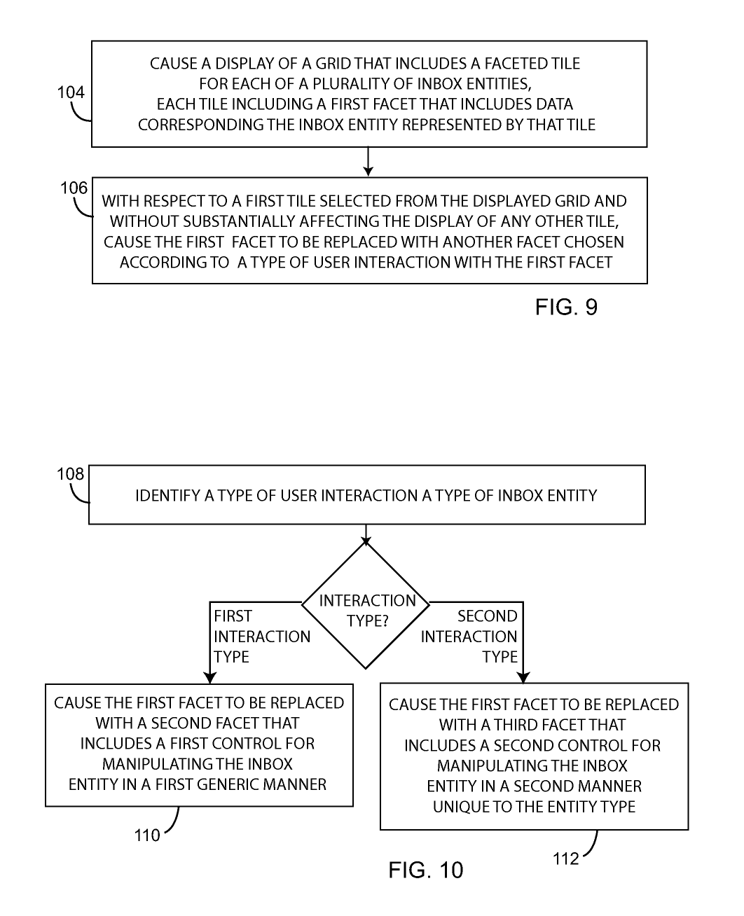

FIG. 9 is a flow diagram of steps taken to implement a method for displaying inbox entities as a grid of faceted tiles. FIG. 10 expands on a method step from FIG. 9. In discussing FIGS. 9-10, reference may be made to the diagrams of FIGS. 1-8 to provide contextual examples. Implementation, however, is not limited to those examples.

Referring to FIG. 9, a tile grid is caused to be displayed (step 104). The displayed grid includes a faceted tile for each of a plurality of inbox entities. A first facet of each tile includes data corresponding to the inbox entity the faceted tile represents. FIG. 1 is an example display of an inbox 10 displaying a grid 12 of faceted tiles 14. In FIG. 2, first facet 20 is depicted to include data 22 corresponding to the inbox entity represented by tile 14. Referring to FIG. 7, tile engine 86 may be responsible for step 104. Tile module 98 of FIG. 8 represents program instructions or code for implementing step 104. As noted above, the display can be caused in a number of fashions including returning content in response to a client request where the content when processed by the client results in the client displaying the grid. Causing may also be accomplished by interacting with an operating system of a device driver to cause a display of the grid.

For a given tile selected from the displayed grid, the first facet is caused to be replaced with another facet chosen according to a type of user interaction with the first facet (step 106). The other facet includes a control for manipulating the inbox entity represented by the given tile. The transition between facets is accomplished without substantially affecting the display of other tiles in the grid. Referring to FIG. 7, facet engine 88 may be responsible for implementing step 106. Facet module 100 of FIG. 8 represents program instructions or code for implementing step 106. FIGS. 4 and 5 aid in depicting various types of user interaction that can lead to the transition from one facet to another. One type of user interaction such as swiping in one direction or selecting a given control can lead to a transition to one facet while swiping in another direction or selecting a different control can lead to the transition to another facet. Furthermore, the displayed tile can be continually transitioned from one facet to another based on a user's continued interactions with the facet currently being displayed.

Moreover, multiple tiles within the grid can be transitioned from one facet to another in same manner discussed above. Where the inbox entities are of varying types, the particular control included in the transitioned facet can depend on the type of inbox entity represented. In this context, FIG. 10 expands on step 106 of FIG. 9. In step 108 the type of interaction with the first facet and the type of inbox entity represented by the given tile are identified. Upon identifying a first interaction type, the first facet is caused to be replaced with a second facet that includes a first control for manipulating the represented entity in a generic matter (step 110). A generic manipulation is a manipulation that can generally apply to all inbox entity types. Examples include delete, archive, setting a reminder. Upon identifying a second user interaction type, the first facet is caused to be replaced with a third facet that includes a control for manipulating the represented inbox entity in a manner unique to the entity type. A unique manipulation is one that applies to the given entity type but that generally does not apply to another entity type. Adding a location to a calendar item or escalating a defect are examples of unique manipulations mentioned earlier.

### CONCLUSION

FIGS. 1-6 depict examples of facet tiles and their inclusion in a displayed. The particular layouts and designs of those faceted tiles are examples only and intended to depict possible implementations. FIGS. 8-9 aid in depicting the architecture, functionality, and operation of various embodiments. In particular, in FIGS. 7 and 8 depict various physical and logical components. Various components are defined at least in part as programs or programming. Each such component, portion thereof, or various combinations thereof may represent in whole or in part a module, segment, or portion of code that comprises one or more executable instructions to implement any specified logical function(s). Each component or various combinations thereof may represent a circuit or a number of interconnected circuits to implement the specified logical function(s).

Embodiments can be realized in any non-transitory computer-readable media for use by or in connection with an instruction execution system such as a computer/processor based system or an ASIC (Application Specific Integrated Circuit) or other system that can fetch or obtain the logic from computer-readable media and execute the instructions contained therein. “Computer-readable media” can be any non-transitory media that can contain, store, or maintain programs and data for use by or in connection with the instruction execution system. Computer readable media can comprise any one of many physical media such as, for example, electronic, magnetic, optical, electromagnetic, or semiconductor media. More specific examples of suitable computer-readable media include, but are not limited to, hard drives, solid state drives, random access memory (RAM), read-only memory (ROM), erasable programmable read-only memory, flash drives, and portable compact discs.

Although the flow diagrams of FIGS. 9-10 show specific orders of execution, the order of execution may differ from that which is depicted. For example, the order of execution of two or more blocks or arrows may be scrambled relative to the order shown. Also, two or more blocks shown in succession may be executed concurrently or with partial concurrence. All such variations are within the scope of the present invention.

The present invention has been shown and described with reference to the foregoing exemplary embodiments. It is to be understood, however, that other forms, details, and embodiments may be made without departing from the spirit and scope of the invention that is defined in the following claims.

1. A system, comprising a memory resource storing instructions that when executed cause a processing resource to:
cause a display of a tile grid that includes a faceted tile for each of a plurality of inbox entities wherein a first facet of each tile includes data corresponding to the inbox entity the faceted tile represents; and
upon detecting a first user interaction with the first facet of a first displayed tile, cause a display of a second facet replacing the first facet of the first displayed tile but not substantially affecting any other displayed tile, the second facet including a first control for interacting with the inbox entity represented by the first displayed tile.

2. The system of claim 1, wherein the instructions, when executed, cause the processing resource to:
upon detecting a second user interaction with the first facet of the first displayed tile, cause a display of a third facet of the selected tile replacing the first facet of the first displayed tile but not substantially affecting any other displayed tile, the third facet including a second control for interacting with the inbox entity represented by the first displayed tile, the second control being different from the first control.

3. The system of claim 2, wherein the instructions, when executed, cause the processing resource to manipulate the inbox entity represented by the first displayed tile according to the user's interaction with the first and second controls.

4. The system of claim 2, wherein the instructions, when executed, cause the processing resource to:
upon detecting a second user interaction with the second facet of the first displayed tile, cause a display of a third facet replacing the second facet of the first displayed tile but not substantially affecting any other displayed tile, the third facet including a third control for interacting with the inbox entity represented by the first selected tile, the third control being different from the first and second controls.

5. The system of claim 1, wherein the inbox entities are of varying types, the inbox entity represented by the first displayed tile is of a first entity type, and the first control is unique to the first entity type, wherein the instructions, when executed, cause the processing resource to:
upon detecting a third interaction with the first facet of a second displayed tile, cause a display of a second facet replacing the first facet of the displayed second tile but not substantially affecting any other displayed tile, the second facet of the second displayed tile including a fourth control for interacting with the inbox entity represented by the second displayed tile; and
wherein the inbox entity represented by the second displayed tile is of a second type different from the first type, and the fourth control is unique to the second type and is different than the first control.

6. The system of claim 5, wherein the instructions, when executed, cause the processing resource to:
manipulate the inbox entity represented by the first selected tile in a first manner unique to the first inbox entity type according to a user interaction with the first control; and
manipulate the inbox entity represented by the second selected tile in a second manner unique to the second inbox entity type according to a user interaction with the fourth control.

7. The system of claim 1, further comprising the processing resource.

8. A computer readable medium storing instructions executable by a processor, the instructions including:
a tile module that when executed causes a display of a grid that includes a faceted tile for each of a plurality of inbox entities wherein a first facet of each tile includes data corresponding a particular one of the inbox entities; and
a facet module that when executed, causes, with respect to a first tile selected from among the displayed tiles and without substantially affecting the display of any other tiles, the first facet of the first tile to be replaced with a second facet or a third facet chosen according to a type of user interaction with that first facet;
wherein the second facet includes a first control and is chosen following a first interaction type and the third facet includes a second control and is chosen following a second interaction type.

9. The medium of claim 8, wherein the instructions include a manipulation module that when executed manipulates the inbox entity represented by the first tile according to the user's interaction with at least one of the first control and the second control.

10. The medium of claim 8, wherein:
the inbox entities are of varying types;
the inbox entity represented by the first tile is of a first entity type;
the first control is unique to the first entity type;
the facet module, when executed, causes, upon a detection of an interaction with the first facet of a second tile selected from among the displayed tiles, the first facet of the second tile to be replaced with a second facet without substantially affecting the display of any other tiles, the second facet of the second tile including a third control for interacting with the inbox entity represented by the second tile; and
the inbox entity represented by the second tile is of a second type different from the first type, and the third control is unique to the second entity type and is different than the first control.

11. The system of claim 10, wherein the instructions include a manipulation module that when executed:
manipulates the inbox entity represented by the first tile in a first manner according to a user interaction with the first control; and
manipulates the inbox entity represented by the second tile in a second manner according to a user interaction with the third control.

12. A system comprising,
a tile engine to cause a display a tile grid that includes a unique tile for each of a plurality of inbox entities wherein each tile is faceted and a first facet of each tile includes data corresponding a particular one of the inbox entities;
a facet engine to, upon a detection of an interaction with a selected tile in the displayed grid, cause the display of the tile to change from the first facet to a second facet without substantially affecting the display of any other tiles within the grid, the second facet including a control corresponding an identified type of the inbox entity represented by the selected tile; and
a manipulation engine to manipulate the inbox entity represented by the selected tile according to a manipulation of the control.

13. The system of claim 12, wherein the grid includes a first tile representing a first inbox entity of a first type and a second tile representing a second inbox entity of a second type, the facet engine is a facet engine to:
upon a detection of a first interaction with the first tile of the displayed grid, cause the display of the first tile to change from the first facet to a second facet that includes a first control corresponding to the first type;
upon a detection of a second interaction with the second tile of the displayed grid, cause the display of the second tile to change from the first facet to a third facet that includes a second control corresponding to the second type.

14. The system of claim 13, wherein the manipulation engine is a manipulation engine to:
manipulate the first inbox entity represented by the first tile according to a manipulation of the first control; and
manipulate the second inbox entity represented by the second tile according to a manipulation of the second control;
wherein the first inbox entity is manipulated differently than the second inbox entity.

15. The system of claim 12 wherein the facet engine is a facet engine to:
upon a detection of a first interaction with a selected tile in the displayed grid, cause the display of the tile to change from the first facet to a second facet without substantially affecting the display of any other tiles within the grid, the second facet including a first control corresponding the identified type of the inbox entity represented by the selected tile; and
upon a detection of a second interaction with the selected tile in the displayed grid, cause the display of the tile to change from the first facet to a third facet without substantially affecting the display of any other tiles within the grid, the third facet including a second control corresponding the identified type of the inbox entity represented by the selected tile.
